(19) United States
(12) Patent Application Publication
(10) Pub. No.: US 2026/0255192 A1
(43) Pub. Date: Aug. 27, 2026

(54) METHOD, WIRELESS COMMUNICATION APPARATUS AND NON-TRANSITORY PROCESSOR-READABLE STORAGE MEDIUM FOR DETECTING WIRELESS INTERFERENCE

(71) Applicant: MediaTek Singapore Pte. Ltd., Singapore (SG)

(72) Inventors: Zhuoliang ZHANG, Beijing (CN); Qinan LI, Beijing (CN)

(21) Appl. No.: 19/064,812

(22) Filed: Feb. 27, 2025

(51) Int. Cl. H04W 24/08

(52) U.S. Cl. CPC H04W 24/08

(57) ABSTRACT

A method for detecting wireless interference is provided. The method is implemented by a wireless communication apparatus. The method includes transmitting a request packet to a network node. The method includes generating a delay event when an acknowledgment (ACK) packet is received from the network node after a first time delay has expired and before a second time delay has expired or when the ACK packet is not received from the network node after the second time delay has expired, wherein the first time delay and the second time delay is started from when the request packet is transmitted. The method includes determining an interference level of a network environment between the wireless communication apparatus and the network node based on an interference level table and a number of delay events within a first period of time.

### BACKGROUND OF THE INVENTION

### Field of the Invention

The present disclosure generally relates to the field of wireless communication technology. More specifically, aspects of the present disclosure relate to a method, a wireless communication apparatus, and a non-transitory processor-readable storage medium for detecting wireless interference.

### Description of the Related Art

Over the past few decades, mobile communications have evolved from voice services to high-speed broadband data services. With further development of new types of businesses and applications, e.g. the mobile Internet and Internet of Things (IoT), the demands on data on mobile networks will continue to increase exponentially. On one hand, data traffic in mobile networks is expected to experience explosive growth in the future. On the other hand, massive equipment connections and diversified services and applications will be key features of future wireless communication systems. People-centered communications and machine-centered communications will coexist and continue to grow. Based on diversified business and application requirements in future mobile communications, wireless communication systems should meet a variety of requirements, such as throughput, latency, reliability, link density, cost, energy consumption, complexity, and coverage.

With the increasing ubiquity of mobile devices, multiple wireless communication devices must often operate in the same space. This may cause multiple wireless communication devices to have the same or adjacent wireless frequencies, resulting in co-channel interference (CCI) or adjacent channel interference (ACI). Both co-channel interference and adjacent channel interference will have negative impacts on wireless communications.

These negative impacts mainly include the reduction of communication quality and the reduction of communication rates. Since both CCI and ACI may cause an increase in the error rate of data packets, data transmission may need to be retransmitted multiple times in a strong interference environment, which will reduce communication efficiency and increase latency, and will also significantly increase the energy consumption of wireless communication devices. In addition, when data transmission is retransmitted multiple times, the transmission rate will be reduced, which will directly affect the user's network experience.

Currently, wireless communication devices can often detect wireless interference by monitoring network performance indicators or traffic statistical data (such as transmission rate, delay, packet loss rate, number of retransmissions, etc.). However, these monitoring indicators can be affected by multiple factors and are difficult to attribute to a single interference factor.

Only by accurately attributing the degradation of network experience to wireless interference can we adopt the correct approach to optimize the network experience. Therefore, there is a need for a method, a wireless communication apparatus, and a non-transitory processor-readable storage medium for detecting wireless interference to solve this problem.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide a method, a wireless communication apparatus, and a non-transitory processor-readable storage medium for detecting wireless interference to accurately detect whether the wireless interference occurs in the current network environment.

In an exemplary embodiment, a method for detecting wireless interference is provided. The method is implemented by a wireless communication apparatus. The method includes transmitting a request packet to a network node. The method includes generating a delay event when an acknowledgment (ACK) packet is received from the network node after a first time delay has expired and before a second time delay has expired or when the ACK packet is not received from the network node after the second time delay has expired, wherein the first time delay and the second time delay is started from when the request packet is transmitted. The method includes determining an interference level of a network environment between the wireless communication apparatus and the network node based on an interference level table and a number of delay events within a first period of time.

In some embodiments, the interference level is further determined based on a time delay value for each delay event generated in the first period of time or a fluctuation in a received signal strength indicator (RSSI) associated with each ACK packet received from the network node.

In some embodiments, the method further comprises triggering to transmit a new request packet to the network node when no new request packet is transmitted to the network node after a second period of time has expired, wherein the second period of time is started from when the request packet is transmitted.

In some embodiments, before determining the interference level of the network environment between the wireless communication apparatus and the network node, the method further comprises: selecting the interference level table from a plurality of interference level tables, wherein the interference level table corresponds to an application that the wireless communication apparatus is running.

In some embodiments, the plurality of interference level tables are predetermined.

In some embodiments, the ACK packet is a layer 2 (L2) packet.

In an exemplary embodiment, a wireless communication apparatus for detecting wireless interference is provided. The device comprises one or more processors and one or more computer storage media for storing one or more computer-readable instructions. The processor is configured to drive the computer storage media to execute the following tasks. The computer storage media transmits a request packet to a network node. The computer storage media generates a delay event when an acknowledgment (ACK) packet is received from the network node after a first time delay has expired and before a second time delay has expired or when the ACK packet is not received from the network node after the second time delay has expired, wherein the first time delay and the second time delay are started from when the request packet is transmitted. The computer storage media determines an interference level of a network environment between the wireless communication apparatus and the network node based on an interference level table and a number of delay events within a first period of time.

In an exemplary embodiment, a non-transitory processor-readable storage medium having stored thereon processor-executable instructions configured to cause a processor of a wireless communication apparatus to detect wireless interference is provided. The processor-executable instructions configured to cause the processor to execute the following tasks: transmitting a request packet to a network node; generating a delay event when an acknowledgment (ACK) packet is received from the network node after a first time delay has expired and before a second time delay has expired or when the ACK packet is not received from the network node after the second time delay has expired, wherein the first time delay and the second time delay are started from when the request packet is transmitted; and determining an interference level of a network environment between the wireless communication apparatus and the network node based on an interference level table and a number of delay events within a first period of time.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a schematic diagram illustrating a wireless communication apparatus detecting wireless interference in a network environment between a network node according to an embodiment of the present disclosure.

FIG. 2 is a schematic diagram illustrating the transmission delay monitor generating a delay event and recording a time delay value corresponding to each request packet according to an embodiment of the present disclosure.

FIG. 3 is a flow chart illustrating the method for detecting wireless interference according to an embodiment of the disclosure.

FIG. 4 illustrates an exemplary operating environment for implementing embodiments of the present disclosure.

### DETAILED DESCRIPTION OF THE INVENTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

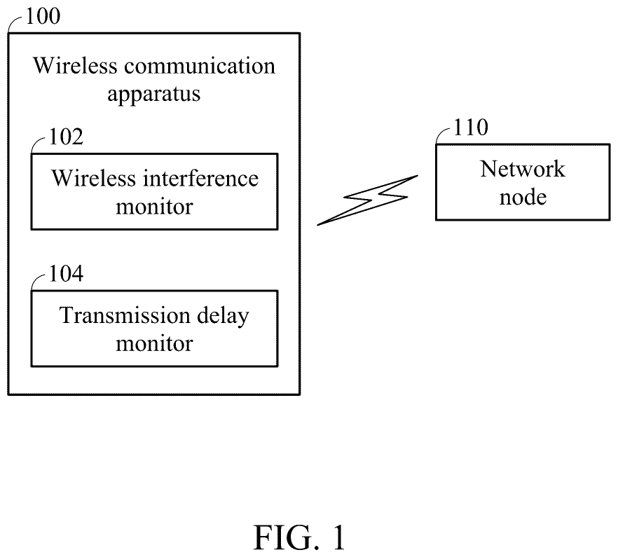

FIG. 1 is a schematic diagram illustrating a wireless communication apparatus 100 detecting wireless interference in a network environment between a network node 110 according to an embodiment of the present disclosure.

The network node 110 may include, but is not limited to, a server, a router, a gateway or other similar devices, and the wireless communication apparatus 100 may include, but is not limited to, a User Equipment (UE), a mobile station, a mobile terminal or device, a user communication radio terminal. For example, a wireless communication apparatus 100 may be a portable radio equipment, which includes, but is not limited to, a mobile phone, a tablet, a wearable device, a sensor, a vehicle, or a Personal Digital Assistant (PDA) with wireless communication capability. The wireless communication apparatus 100 is configured to receive and transmit signals over an air interface to the network node 110 in a wireless network.

The wireless interference monitor 102 may transmit a request packet to the network node 110 via the transmission delay monitor 104. When the transmission delay monitor 104 receives an acknowledgment (ACK) packet from the network node 110 after a first time delay has expired and before a second time delay has expired or when the transmission delay monitor 104 does not receive the ACK packet from the network node 110 after the second time delay has expired, the transmission delay monitor 104 generates a delay event and reports the delay event to the wireless interference monitor 102, wherein the first time delay and the second time delay is started from when the request packet is transmitted. In one embodiment, the ACK packet is a layer 2 (L2) packet.

In some embodiments, the first time delay and the second time delay may be adjusted by the wireless interference monitor 102 according to different applications (e.g., web browser, game, video or other application) running at the wireless communication apparatus 100.

Specifically, the transmission delay monitor 104 is mainly configured to monitor the time from transmitting the request packet to receiving the ACK packet. When the interference in the wireless network environment is strong, it will cause the wireless communication apparatus 100 to spend more time transmitting the request packet to receiving the ACK packet. On the contrary, the smaller the interference in the wireless network environment, the less time it takes. Therefore, the transmission delay monitor 104 may reflect the interference intensity of the wireless network environment.

In addition, the transmission delay monitor 104 may count the time from transmitting a request packet to the network node 110 to receiving an acknowledgment (ACK) packet from the network node 110. In other words, the transmission delay monitor 104 may also record a time delay value corresponding to each request packet and transmit the time delay value to the wireless interference monitor 102.

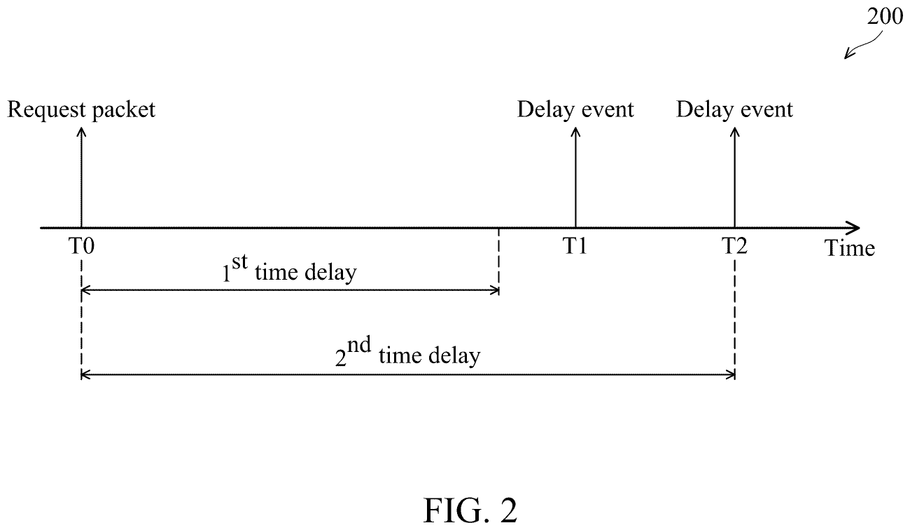

FIG. 2 is a schematic diagram 200 illustrating the transmission delay monitor generating a delay event and recording a time delay value corresponding to each request packet according to an embodiment of the present disclosure.

As shown in FIG. 2, TO is the time point when the wireless communication apparatus 100 transmits a request packet, the first time delay and the second time delay preset by the wireless interference monitor 102, wherein the first time delay is less than the second time delay.

When the wireless communication apparatus 100 receives an ACK packet from the network node 110 within the first time delay, the transmission delay monitor 104 does not generate a delay event to the wireless interference monitor 102. When the wireless communication apparatus 100 receives an ACK packet from the network node 110 after the first time delay has expired and before the second time delay has expired, the transmission delay monitor 104 generates a delay event and reports the delay event to the wireless interference monitor 102. For example, when the wireless communication apparatus 100 receives an ACK packet at T1, the transmission delay monitor 104 generates a delay event and reports the delay event to the wireless interference monitor 102 at T1, wherein the delay event may comprise a time delay value, T1. When the wireless communication apparatus 100 does not receive an ACK packet after the second time delay has expired, the transmission delay monitor 104 generates a delay event and reports the delay event a delay event to the wireless interference monitor 102 at T2, wherein the delay event may comprise a time delay value, T2.

Return to FIG. 1, the wireless interference monitor 102 may predetermine a plurality of interference level tables corresponds to different applications that the wireless communication apparatus is running. The wireless interference monitor may select an interference level table from a plurality of interference level tables according to the application that the wireless communication apparatus is running. TABLE 1 gives an example of an interference level table.

TABLE 1

| Interference level | Number of delay events | Time delay value |
|---|---|---|
| 0 | [0, 10] | P95 < 5 ms |
| 1 | [11, 20] | P95 < 30 ms |
| 2 | [21, 44] | P95 < 50 ms |
| 3 | [45, 99] | P95 < 100 ms |
| 4 | >99 | P95 >= 5 ms |

As shown in TABLE 1, the horizontal axis of TABLE 1 describes the number of delay events, and the time delay value. The wireless interference monitor 102 may determine the interference level of a network environment between the wireless communication apparatus 100 and the network node 110 based on at least one of the number of delay events and the time delay value.

For example, the number of delay events counted by the wireless interference monitor 102 in the first period of time is 8. The wireless interference monitor 102 sorts the time delay values corresponding to the 8 delay events from small to large, and obtains the time delay value, 3 milliseconds (ms), at the 95% position (P95) in the order. Therefore, the wireless interference monitor 102 determines that the interference level of the current network environment is 0 according to TABLE 1, which means that no interference occurs in the network environment.

For another example, it is assumed that the number of delay events counted by the wireless interference monitor 102 in the first period of time is 13, and the time delay value at the 95% position (P95) is 15 ms. The wireless interference monitor 102 determines that the interference level of the current network environment is 1 according to TABLE 1, which means that small interference occurs in the network environment.

For yet another example, it is assumed that the number of delay events counted by the wireless interference monitor 102 in the first period of time is 15, and the time delay value at the 95% position (P95) is 3 ms. Although the number of delay events corresponds to the interference level of 1, since P95 is less than 5 ms, the wireless interference monitor 102 still determines that the interference level of the current network environment is 0.

In some embodiments, the interference level table may also comprise other factors to determine the interference level, as shown in TABLE 2.

TABLE 2

| | Number of delay | | RSSI Delta |
|---|---|---|---|
| Interference level | events | Time delay value | (dBm) |
| 0 | [0, 10] | P95 < 5 ms | 10 |
| 1 | [11, 20] | P95 < 30 ms | 10 |
| 2 | [21, 44] | P95 < 50 ms | 10 |
| 3 | [45, 99] | P95 < 100 ms | 10 |
| 4 | >99 | P95 >= 5 ms | 10 |

A fluctuation in a received signal strength indicator (RSSI Delta) associated with each ACK packet received from the network node may added in the horizontal axis of TABLE 2. The wireless interference monitor 102 may determine the interference level of a network environment between the wireless communication apparatus 100 and the network node 110 based on the number of delay events, the time delay value and the RSSI delta.

For example, it is assumed that the number of delay events counted by the wireless interference monitor 102 in the first period of time is 28, the time delay value at the 95% position (P95) is 40 ms and the RSSI delta is 10 dBm. The wireless interference monitor 102 determines that the interference level of the current network environment is 2 according to TABLE 1.

It should be noted that the interference level table is not used to limit the present disclosure, and those skilled in the art can make appropriate replacements or adjustments according to this embodiment.

In some embodiments, in order to prevent the number of request packets transmitted to the network node 110 from being too small, causing the wireless communication apparatus to not detect the interference level of the network environment for a long time, the wireless interference monitor 102 may trigger to transmit a new request packet to the network node 110 when no request packet is transmitted to the network node 110 after a second period of time has expired, wherein the second period of time is started from when the request packet is transmitted. In other words, the wireless interference monitor 102 may periodically detect the interference level of the network environment.

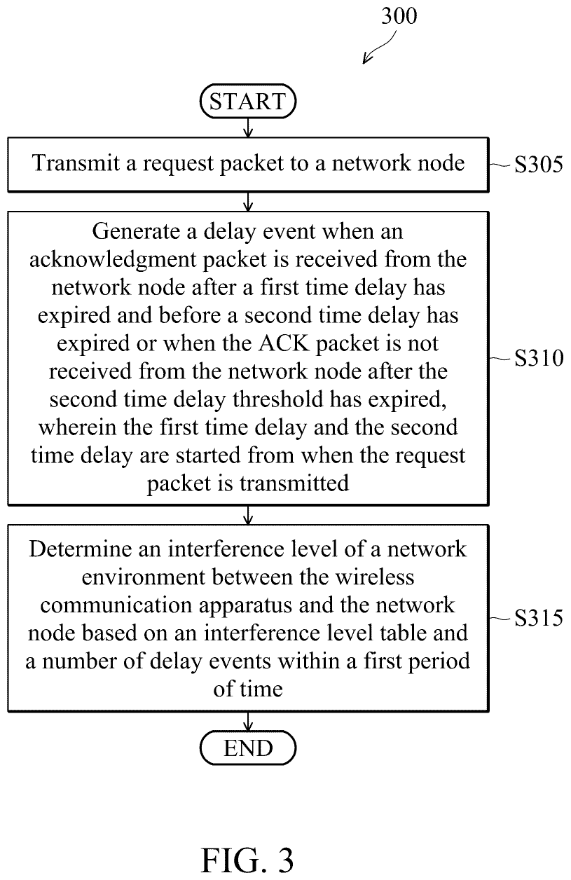

FIG. 3 is a flow chart 300 illustrating the method for detecting wireless interference according to an embodiment of the disclosure. In this embodiment, the method is applied to the wireless communication apparatus 100 in FIG. 1.

In step S305, the wireless communication apparatus transmits a request packet to a network node.

Then, in step S310, the wireless communication apparatus generates a delay event when an acknowledgment (ACK) packet is received from the network node after a first time delay has expired and before a second time delay has expired or when the ACK packet is not received from the network node after the second time delay has expired, wherein the first time delay and the second time delay is started from when the request packet is transmitted. In some embodiment, the ACK packet is a layer 2 (L2) packet.

In step S315, the wireless communication apparatus determines an interference level of a network environment between the wireless communication apparatus and the network node based on an interference level table and a number of delay events within a first period of time.

In some embodiments, the wireless communication apparatus may further determine the interference level based on a time delay value for each delay event generated in the first period of time or a fluctuation in a RSSI associated with each ACK packet received from the network node.

In some embodiments, before determining the interference level of the network environment between the wireless communication apparatus and the network node in step S315, the wireless communication apparatus may select the interference level table from a plurality of interference level tables, wherein the interference level table corresponds to an application that the wireless communication apparatus is running, and the plurality of interference level tables are predetermined by the wireless communication apparatus.

In some embodiments, the wireless communication apparatus may trigger to transmit a new request packet to the network node when no new request packet is transmitted to the network node after a second period of time has expired, wherein the second period of time is started from when the request packet is transmitted. In yet another embodiment, the second period of time is longer than the first period of time.

As mentioned above, a method, a wireless communication apparatus, and a non-transitory processor-readable storage medium for detecting wireless interference in the disclosure may accurately determine whether the interference has occurred in the network environment, so as to use the correct method to optimize the network experience.

It should be noted that the wireless interference monitor 102 and the transmission delay monitor 104 in FIG. 1 may be implemented in hardware, software, firmware, or any combination thereof. For example, the wireless interference monitor 102 and the transmission delay monitor 104 may be implemented as computer program code configured to be executed in one or more processors. Alternatively, the wireless interference monitor 102 and the transmission delay monitor 104 may be implemented as hardware logic/electrical circuitry.

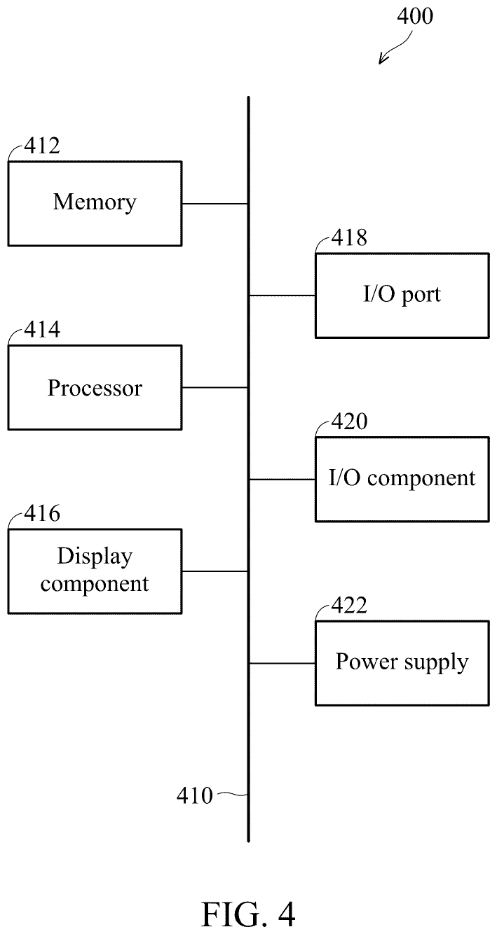

The embodiments described herein, including systems, methods/processes, and/or apparatuses, may be implemented using well known servers/computers, such as a computing device 400 shown in FIG. 4. For example, the wireless communication apparatus 100 can be implemented using one or more computing device 400. The computing device 400 is described as follows, for purposes of illustration.

Referring to FIG. 4, an exemplary operating environment for implementing embodiments of the present disclosure is shown and generally known as a computing device 400. The computing device 400 is merely an example of a suitable computing environment and is not intended to limit the scope of use or functionality of the disclosure. Neither should the computing device 400 be interpreted as having any dependency or requirement relating to any one or combination of components illustrated.

The disclosure may be realized by means of the computer code or machine-useable instructions, including computer-executable instructions such as program modules, being executed by a computer or other machine, such as a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 4, the computing device 400 may include a bus 410 that is directly or indirectly coupled to the following devices: one or more memories 412, one or more processors 414, one or more display components 416, one or more input/output (I/O) ports 418, one or more input/output components 420, and an illustrative power supply 422. The bus 410 may represent one or more kinds of busses (such as an address bus, data bus, or any combination thereof). Although the various blocks of FIG. 4 are shown with lines for the sake of clarity, and in reality, the boundaries of the various components are not specific. For example, the display component such as a display device may be considered an I/O component and the processor may include a memory.

The computing device 400 typically includes a variety of computer-readable media. The computer-readable media can be any available media that can be accessed by computing device 400 and includes both volatile and nonvolatile media, removable and non-removable media. By way of example, not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the computing device 400. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 412 may include computer-storage media in the form of volatile and/or nonvolatile memory. The memory may be removable, non-removable, or a combination thereof. Exemplary hardware devices include solid-state memory, hard drives, optical-disc drives, etc. The computing device 400 includes one or more processors that read data from various entities such as the memory 412 or the I/O components 420. The display component(s) 416 present data indications to a user or to another device. Exemplary presentation components include a display device, speaker, printing component, vibrating component, etc.

The I/O ports 418 allow the computing device 400 to be logically coupled to other devices including the I/O components 420, some of which may be embedded. Illustrative components include a microphone, joystick, game pad, satellite dish, scanner, printer, wireless device, etc. The I/O components 420 may provide a natural user interface (NUI) that processes gestures, voice, or other physiological inputs generated by a user. For example, inputs may be transmitted to an appropriate network element for further processing. A NUI may be implemented to realize speech recognition, touch and stylus recognition, facial recognition, biometric recognition, gesture recognition both on screen and adjacent to the screen, air gestures, head and eye tracking, touch recognition associated with displays on the computing device 400, or any combination thereof. The computing device 400 may be equipped with depth cameras, such as stereoscopic camera systems, infrared camera systems, RGB camera systems, or any combination thereof, to realize gesture detection and recognition. Furthermore, the computing device 400 may be equipped with accelerometers or gyroscopes that enable detection of motion. The output of the accelerometers or gyroscopes may be provided to the display of the computing device 400 to carry out immersive augmented reality or virtual reality.

Furthermore, the processor 414 in the computing device 400 can execute the program code in the memory 412 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for detecting wireless interference, implemented by a wireless communication apparatus, comprising:
transmitting a request packet to a network node;
generating a delay event when an acknowledgment (ACK) packet is received from the network node after a first time delay has expired and before a second time delay has expired or when the ACK packet is not received from the network node after the second time delay has expired, wherein the first time delay and the second time delay is started from when the request packet is transmitted; and
determining an interference level of a network environment between the wireless communication apparatus and the network node based on an interference level table and a number of delay events within a first period of time.

2. The method for detecting wireless interference as claimed in claim 1, wherein the interference level is further determined based on a time delay value for each delay event generated in the first period of time or a fluctuation in a received signal strength indicator (RSSI) associated with each ACK packet received from the network node.

3. The method for detecting wireless interference as claimed in claim 1, further comprising:
triggering to transmit a new request packet to the network node when no new request packet is transmitted to the network node after a second period of time has expired, wherein the second period of time is started from when the request packet is transmitted.

4. The method for detecting wireless interference as claimed in claim 1, wherein before determining the interference level of the network environment between the wireless communication apparatus and the network node, the method further comprises:
selecting the interference level table from a plurality of interference level tables, wherein the interference level table corresponds to an application that the wireless communication apparatus is running.

5. The method for detecting wireless interference as claimed in claim 4, wherein the plurality of interference level tables are predetermined.

6. The method for detecting wireless interference as claimed in claim 1, wherein the ACK packet is a layer 2 (L2) packet.

7. A wireless communication apparatus for detecting wireless interference, comprising:
one or more processors; and
one or more computer storage media for storing one or more computer-readable instructions, wherein the processor is configured to drive the one or more computer storage media to execute the following tasks:
transmitting a request packet to a network node;
generating a delay event when an acknowledgment (ACK) packet is received from the network node after a first time delay has expired and before a second time delay has expired or when the ACK packet is not received from the network node after the second time delay has expired, wherein the first time delay and the second time delay are started from when the request packet is transmitted; and
determining an interference level of a network environment between the wireless communication apparatus and the network node based on an interference level table and a number of delay events within a first period of time.

8. The wireless communication apparatus for detecting wireless interference as claimed in claim 7, wherein the interference level is further determined based on a time delay value for each delay event generated in the first period of time or a fluctuation in a received signal strength indicator (RSSI) associated with each ACK packet received from the network node.

9. The wireless communication apparatus for detecting wireless interference as claimed in claim 7, wherein the processor is further configured to drive the one or more computer storage media to execute the following tasks:
triggering to transmit a new request packet to the network node when no new request packet is transmitted to the network node after a second period of time has expired, wherein the second period of time is started from when the request packet is transmitted.

10. The wireless communication apparatus for detecting wireless interference as claimed in claim 7, wherein before determining the interference level of the network environment between the wireless communication apparatus and the network node, the processor further executes the following tasks:
selecting the interference level table from a plurality of interference level tables, wherein the interference level table corresponds to an application that the wireless communication apparatus is running.

11. The wireless communication apparatus for detecting wireless interference as claimed in claim 10, wherein the plurality of interference level tables is predetermined.

12. The wireless communication apparatus for detecting wireless interference as claimed in claim 7, wherein the ACK packet is a layer 2 (L2) packet.

13. A non-transitory processor-readable storage medium having stored thereon processor-executable instructions configured to cause a processor of a wireless communication apparatus to detect wireless interference, wherein the processor-executable instructions are configured to cause the processor to execute the following tasks:
transmitting a request packet to a network node;
generating a delay event when an acknowledgment (ACK) packet is received from the network node after a first time delay has expired and before a second time delay has expired or when the ACK packet is not received from the network node after the second time delay has expired, wherein the first time delay and the second time delay are started from when the request packet is transmitted; and
determining an interference level of a network environment between the wireless communication apparatus and the network node based on an interference level table and a number of delay events within a first period of time.

14. The non-transitory processor-readable storage medium as claimed in claim 13, wherein the interference level is further determined based on a time delay value for each delay event generated in the first period of time or a fluctuation in a received signal strength indicator (RSSI) associated with each ACK packet received from the network node.

15. The non-transitory processor-readable storage medium as claimed in claim 13, wherein the processor-executable instructions are further configured to cause the processor to execute the following tasks:
triggering to transmit a new request packet to the network node when no new request packet is transmitted to the network node after a second period of time has expired, wherein the second period of time is started from when the request packet is transmitted.

16. The non-transitory processor-readable storage medium as claimed in claim 13, wherein before determining the interference level of the network environment between the wireless communication apparatus and the network node, the processor-executable instructions are further configured to cause the processor to execute the following tasks:
selecting the interference level table from a plurality of interference level tables, wherein the interference level table corresponds to an application that the wireless communication apparatus is running.

17. The non-transitory processor-readable storage medium as claimed in claim 16, wherein the plurality of interference level tables is predetermined.

18. The non-transitory processor-readable storage medium as claimed in claim 13, wherein the ACK packet is a layer 2 (L2) packet.
